(19) United States
(12) Patent Application Publication
(10) Pub. No.: US 2025/0262864 A1
(43) Pub. Date: Aug. 21, 2025

(54) MAINTENANCE UNIT AND LIQUID EJECTION DEVICE

(71) Applicant: SEIKO EPSON CORPORATION, Tokyo (JP)

(72) Inventors: Akihiro GOTO, YAMAGATA-MURA (JP); Ryoji FUJIMORI, SUWA-SHI (JP); Toshio ARIMURA, SHIOJIRI-SHI (JP)

(21) Appl. No.: 19/057,399

(22) Filed: Feb. 19, 2025

(30) Foreign Application Priority Data
Feb. 21, 2024 (JP) 2024-024353

(51) Int. Cl. B41J 2/165

(52) U.S. Cl. CPC B41J 2/16552; B41J 2/1652; B41J 2002/16558; B41P 2235/242; B41P 2235/244

(57) ABSTRACT

A maintenance unit includes a wiping section 55 configured to wipe the nozzle forming surface 25 of a liquid ejection section 22 in which nozzles for ejecting a first liquid are formed, and a mixed fluid spray section that sprays a mixed fluid of gas and a second liquid from a spray nozzle 93 to moisten the wiping section 55.

The present application is based on, and claims priority from JP Application Serial Number 2024-024353, filed Feb. 21, 2024, the disclosure of which is hereby incorporated by reference herein in its entirety.

### BACKGROUND

### 1. Technical Field

The present disclosure relates to a maintenance unit and a liquid ejection device.

### 2. Related Art

For example, there is an inkjet recording device, which is an example of a liquid ejection device, such as JP-A-2018-30347. The inkjet recording device is equipped with a head, which is an example of a liquid ejection section, a wiping mechanism, and a supply mechanism. The head prints by ejecting liquid, which is an example of first liquid, from nozzles arranged on a nozzle surface, which is an example of a nozzle forming surface. The wiping mechanism wipes the nozzle surface with a wiping sheet. The supply mechanism supplies washing liquid, which is an example of a second liquid, to the wiping sheet from a supply pipe in which a hole is opened.

The supply mechanism described in JP-A-2018-30347 supplies the washing liquid to the wiping sheet by rotating the supply pipe such that the hole faces downward. When dropping the washing liquid onto the wiping sheet from the hole, a large amount of washing liquid is required to make the entire wiping sheet a uniformly moistened state.

### SUMMARY

In order to overcome the above problem, a maintenance unit includes a wiping section configured to wipe a nozzle forming surface of a liquid ejection section in which a nozzle that ejects a first liquid is formed and a mixed fluid spray section that sprays a mixed fluid of gas and a second liquid from a spray nozzle to moisten the wiping section.

In order to overcome the above problem, a liquid ejection device includes a liquid ejection section that has a nozzle forming surface in which a nozzle that ejects a first liquid is formed and a maintenance unit above.

### BRIEF DESCRIPTION OF THE DRAWINGS

FIG. 1 is a schematic diagram of a first embodiment of a liquid ejection device.

FIG. 2 is a perspective view of a wiping device.

FIG. 3 is a schematic sectional view of a fluid liquid spray head and the wiping device.

FIG. 4 is a perspective view of the pressing section.

FIG. 5 is a schematic sectional view of the wiping device in which the wiping section is located at a wiping position.

FIG. 6 is a side view of a maintenance unit.

FIG. 7 is a schematic sectional view of the fluid liquid spray head and the wiping device.

FIG. 8 is a schematic sectional view of a second embodiment of the fluid liquid spray head and the wiping device.

### DESCRIPTION OF EMBODIMENTS

### First Embodiment

Hereinafter, a first embodiment of a maintenance unit and a liquid ejection device will be described with reference to the drawings. The liquid ejection device is, for example, an inkjet printer that prints images such as characters and photographs by ejecting ink, which is an example of first liquid, onto a medium such as a paper sheet or cloth.

In the drawing, assuming that the liquid ejection device 11 is placed on a horizontal surface, a direction of gravity is indicated by a Z-axis, and directions along the horizontal surface are indicated by an X-axis and a Y-axis. The X-axis, the Y-axis, and the Z-axis are orthogonal to each other. In the following description, a direction parallel to the X-axis is also referred to as a scanning direction X1 and a wiping direction X2, a direction parallel to the Y-axis is also referred to as a width direction Y, and a direction parallel to the Z-axis is also referred to as the vertical direction Z. The wiping direction X2 is a direction opposite to the scanning direction X1.

### Liquid Ejection Device

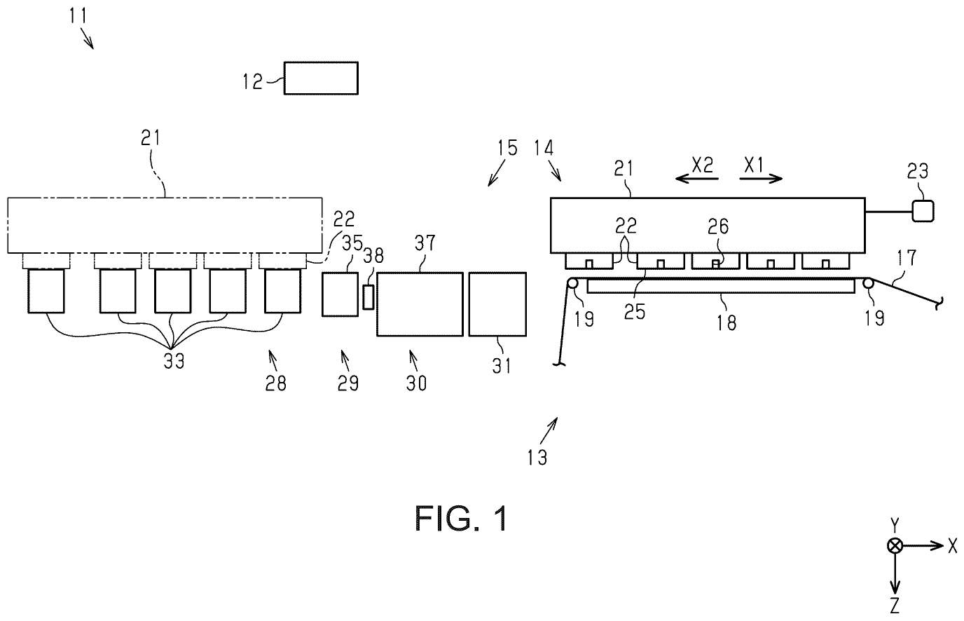

As shown in FIG. 1, the liquid ejection device 11 may equipped with a control section 12, a medium transport section 13, a printing section 14, and a maintenance section 15.

The control section 12 integrally controls drive of each mechanism in the liquid ejection device 11, and controls various operations performed in the liquid ejection device 11. The control section 12 can be configured as a circuit that includes α: one or more processors that execute various processes in accordance with computer programs, β: one or more dedicated hardware circuits that execute at least some of the various processes, or γ: a combination thereof. The hardware circuit is, for example, an application-specific integrated circuit. The processor includes a CPU and a memory, such as a RAM and a ROM, and the memory stores program code or instructions configured to cause the CPU to execute processes. The memory, or computer readable media, includes any readable media that can be accessed by a general-purpose or dedicated computer.

### Medium Transport Section

The medium transport section 13 is configured to transport a medium 17. The medium transport section 13 may be equipped with a medium support section 18 and a transport roller 19.

The medium support section 18 supports a medium 17. The medium support section 18 supports, for example, the medium 17 from below. The medium support section 18 supports the medium 17 to be transported. The medium transport section 13 may be equipped with a plurality of transport rollers 19. The transport rollers 19 transport a medium 17 by rotating.

The medium transport section 13, for example, intermittently transports a medium 17. Specifically, the medium transport section 13 stops transporting a medium 17 while the printing section 14 performs printing on the medium 17. The medium transport section 13 transports the medium 17 after printing is performed on the medium 17. The medium transport section 13 may transport not only an elongated medium 17 but also a cut sheet medium 17.

### Printing Section

The printing section 14 is configured to perform printing on a medium 17. The printing section 14 performs printing on a region of the medium 17 that is supported by the medium support section 18. The printing section 14 may be equipped with a first carriage 21, a liquid ejection section 22, and a pressurizing section 23.

The first carriage 21 is configured to reciprocate in the scanning direction X1 and the wiping direction X2. The first carriage 21 reciprocates in the scanning direction X1 and the wiping direction X2, thereby passing through a position facing the medium 17. The first carriage 21 passes, for example, above the medium support section 18.

In the liquid ejection device 11 of the present embodiment, a direction in which the first carriage 21 moves and a direction in which the medium 17 moves on the medium support section 18 coincide with each other. In other words, the liquid ejection device 11 is a lateral printer. The liquid ejection device 11 may be a serial printer in which a medium 17 is transported in a direction different from the scanning direction X1.

The printing section 14 may be equipped with a plurality of liquid ejection sections 22. The printing section 14 of the present embodiment is equipped with five liquid ejection sections 22. The plurality of liquid ejection sections 22 may be provided side by side in the scanning direction X1. Each of the plurality of liquid ejection sections 22 has a similar configuration. Therefore, one liquid ejection section 22 will be described below.

The liquid ejection section 22 is configured to eject first liquid. The liquid ejection section 22 of the present embodiment ejects the first liquid in the vertical direction Z. The liquid ejection section 22 has a nozzle forming surface 25. Nozzles 26 are formed on the nozzle forming surface 25. The nozzle forming surface 25 is a surface on which one or more nozzles 26 are opened. The liquid ejection section 22 ejects the first liquid from the nozzles 26. The liquid ejection section 22 is mounted on the first carriage 21. The liquid ejection section 22 ejects the first liquid onto the medium 17, thereby printing an image on the medium 17. The plurality of liquid ejection sections 22 may each eject the same types of first liquid or may each eject different types of first liquid. For example, four liquid ejection sections 22 may eject inks of different colors, and one liquid ejection section 22 may eject reaction liquid for aggregating the inks.

The liquid ejection section 22 is, for example, a line head that can simultaneously eject the first liquid onto the medium 17 over the width direction Y. The liquid ejection section 22 is movable in the scanning direction X1. The liquid ejection section 22 is movable in the wiping direction X2. The liquid ejection section 22 reciprocates in the scanning direction X1 and the wiping direction X2 together with the first carriage 21. The liquid ejection section 22 can eject the first liquid over the entire region of the medium 17 supported by the medium support section 18.

The pressurizing section 23 is connected to the liquid ejection section 22. The pressurizing section 23, for example, pressurizes inside the plurality of liquid ejection sections 22. The printing section 14 may be equipped with a plurality of pressurizing sections 23. For example, the printing section 14 may be equipped with the pressurizing sections 23 for each liquid ejection section 22.

The pressurizing section 23 is, for example, a pump. The pressurizing section 23 pressurizes inside the liquid ejection sections 22 to discharge the first liquid from the liquid ejection sections 22. In other words, the pressurizing section 23 pressurizes the inside the liquid ejection sections 22, thereby causing the first liquid to be pressurized and discharged from the nozzles 26. Pressurizing and then discharging the first liquid is also referred to as pressurized cleaning. The pressurized cleaning is a maintenance in which bubbles and foreign matter are forced out from the nozzles 26 along with the first liquid inside the liquid ejection section 22 by forcing the first liquid from the nozzles 26.

### Maintenance Section

The maintenance section 15 is configured to maintain the liquid ejection section 22. The maintenance section 15 may be equipped with a moisture retention section 28, a cleaning section 29, a maintenance unit 30, and a liquid receiving section 31. The moisture retention section 28, the cleaning section 29, the maintenance unit 30, the liquid receiving section 31, and the medium support section 18 may be provided side by side in this order in the scanning direction X1.

The moisture retention section 28 may be equipped with one or more moisture retention caps 33. The moisture retention section 28 may be equipped with the same number of moisture retention caps 33 as the liquid ejection sections 22. The moisture retention cap 33 forms a space that communicates with the nozzles 26 by contacting the liquid ejection section 22. The moisture retention cap 33 caps the liquid ejection section 22, which is located at a home position indicated by a two-dot chain line in FIG. 1. The moisture retention cap 33 caps the liquid ejection section 22, thereby moistening the nozzles 26.

The cleaning section 29 performs suction cleaning of the liquid ejection sections 22 by sucking the first liquid from the liquid ejection sections 22. The cleaning section 29 may be equipped with one or more suction caps 35. The cleaning section 29 may individually clean the plurality of liquid ejection sections 22. The cleaning section 29 may collectively clean the plurality of liquid ejection sections 22.

The suction cap 35, by contacting with the liquid ejection section 22, forms a space that communicates with the nozzles 26. The suction cap 35 caps the liquid ejection section 22. The cleaning section 29 performs suction cleaning by creating a negative pressure by sucking air inside of the suction cap 35. By performing the suction cleaning on the liquid ejection section 22 that is not filled with the first liquid, the first liquid is filled in the liquid ejection section 22. By performing suction cleaning on the liquid ejection section 22 that is filled with the first liquid, air bubbles, foreign matter, and the like are discharged from the inside the liquid ejection section 22. The suction cap 35 receives the first liquid that is discharged by the suction cleaning.

The liquid receiving section 31 is configured to receive the first liquid discharged from the nozzles 26. The liquid receiving section 31 may receive the first liquid discharged from the liquid ejection section 22 by the pressure applied by the pressurizing section 23. In other words, the liquid receiving section 31 may receive the first liquid that is discharged by the pressurized cleaning. The liquid receiving section 31 may receive the first liquid ejected as a dummy ejection. The dummy ejection is an operation of ejecting the first liquid from the nozzles 26 in order to suppress clogging of the nozzles 26. The dummy ejection is also referred to as flushing. For example, a thickened first liquid is discharged from the nozzles 26 by the dummy ejection. The liquid receiving section 31 receives the first liquid discharged from the liquid ejection section 22 facing the liquid receiving section 31.

### Maintenance Unit

As shown in FIG. 1, the maintenance unit 30 may be equipped with a wiping device 37 and a mixed fluid spray section 38.

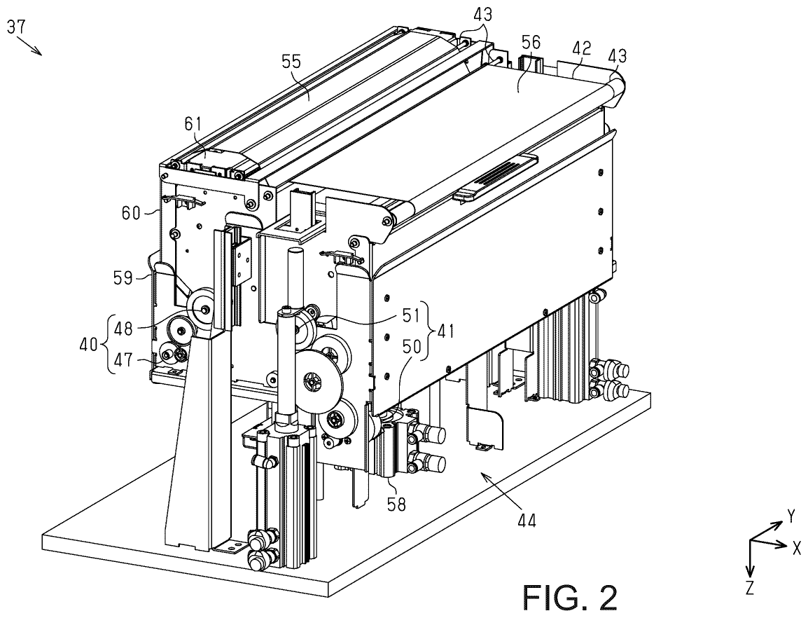

As shown in FIG. 2, the wiping device 37 may be equipped with a feed section 40, a winding section 41, a absorbent member 42, a guide roller 43, and a first movement mechanism 44. The wiping device 37 may be equipped with a plurality of guide rollers 43.

The feed section 40 may be equipped with a braking section 47 and a feed shaft 48. The braking section 47 restricts rotation of the feed shaft 48. The braking section 47 applies a load to the rotating feed shaft 48. The feed shaft 48 supports an unused absorbent member 42 wound in a roll shape. The feed shaft 48 rotates to feed the unused absorbent member 42.

The winding section 41 can wind up the absorbent member 42. The winding section 41 may be equipped with a first drive source 50 and a winding shaft 51. The first drive source 50 is, for example, a motor. The first drive source 50 rotates the winding shaft 51. The winding shaft 51 winds up and supports the used absorbent member 42 in a roll shape.

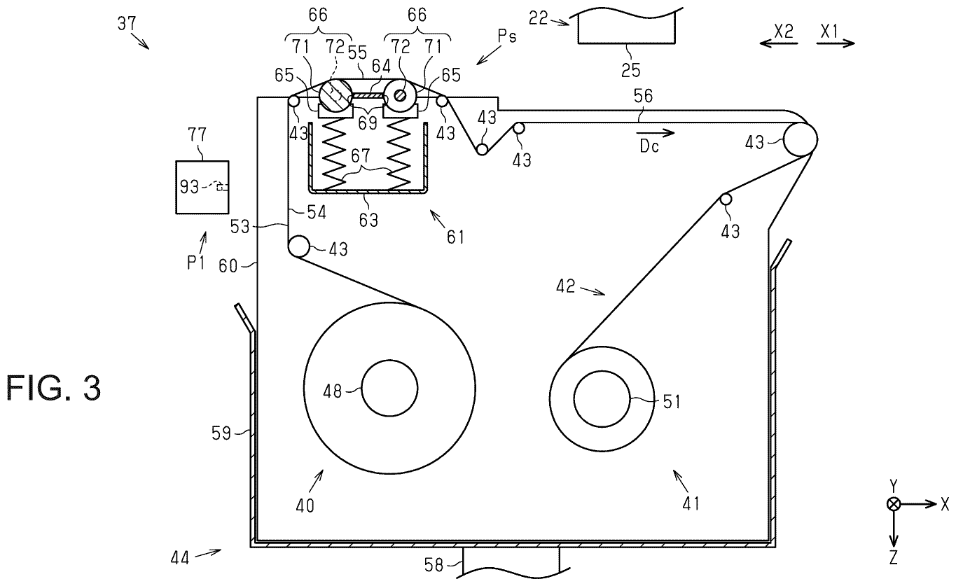

As shown in FIG. 3, the absorbent member 42 is band-shaped. The absorbent member 42 is wound around a plurality of guide rollers 43. The plurality of guide rollers 43 extend, for example, in the width direction Y. The absorbent member 42 fed from the feed section 40 is transported to the winding section 41 via a plurality of guide rollers 43. The absorbent member 42 is fed in the transport direction Dc from the feed section 40 toward the winding section 41. The transport direction Dc is a direction along the path along which the absorbent member 42 is transported.

The absorbent member 42 can absorb liquid. The absorbent member 42 is, for example, cloth. The length of the absorbent member 42 in the width direction Y may be longer than the length of the nozzle forming surface 25 in the width direction Y.

The absorbent member 42 has a contact surface 53 and a back surface 54. The contact surface 53 is a surface that contacts the nozzle forming surface 25. The back surface 54 is a surface opposite to the contact surface 53. The absorbent member 42 has a wiping section 55. In other words, the wiping section 55 is formed of the absorbent member 42. The absorbent member 42 may have a flat section 56. The flat section 56 may be located downstream of the wiping section 55 in the transport direction Dc. The flat section 56 may be arranged between the wiping section 55 and the liquid receiving section 31 in the scanning direction X1. The wiping section 55 may be arranged between the cleaning section 29 and the flat section 56 in the scanning direction X1. In the scanning direction X1, the liquid receiving section 31 may be arranged on the downstream side of the wiping section 55.

As shown in FIG. 3, when the absorbent member 42 is located at a separation position Ps, the wiping section 55 and the flat section 56 are located below the nozzle forming surface 25. The separation position Ps is a location where the absorbent member 42 is separated from the nozzle forming surface 25. The wiping section 55 and the flat section 56, when located at the separation position Ps, do not interfere with the liquid ejection section 22 that reciprocates in the scanning direction X1.

The first movement mechanism 44 may be equipped with a raising and lowering section 58, a holder 59, an accommodation frame 60, and a pressing section 61. The holder 59 detachably holds the accommodation frame 60. The accommodation frame 60 rotatably supports the feed shaft 48 and the winding shaft 51. The user can replace the absorbent member 42 by removing the accommodation frame 60 from the holder 59 and removing the feed shaft 48 and the winding shaft 51 from the accommodation frame 60.

The raising and lowering section 58 is, for example, an air cylinder. The raising and lowering section 58 reciprocates the holder 59 in the vertical direction Z. The raising and lowering section 58 moves the holder 59 and the accommodation frame 60 supported by the holder 59. In other words, the first movement mechanism 44 causes the entire absorbent member 42 to reciprocate in the vertical direction Z.

The pressing section 61 is configured to press the wiping section 55 against the nozzle forming surface 25. The absorbent member 42 is wound around the pressing section 61. The pressing section 61 is equipped with a holding member 63, a cover member 64, an attachment member 65, a roller 66, and an elastic member 67. The pressing section 61 may be equipped with a plurality of each of the attachment members 65, the rollers 66, and the elastic members 67. The holding member 63 and the cover member 64 form a space that accommodates the attachment members 65, the rollers 66, and the elastic members 67.

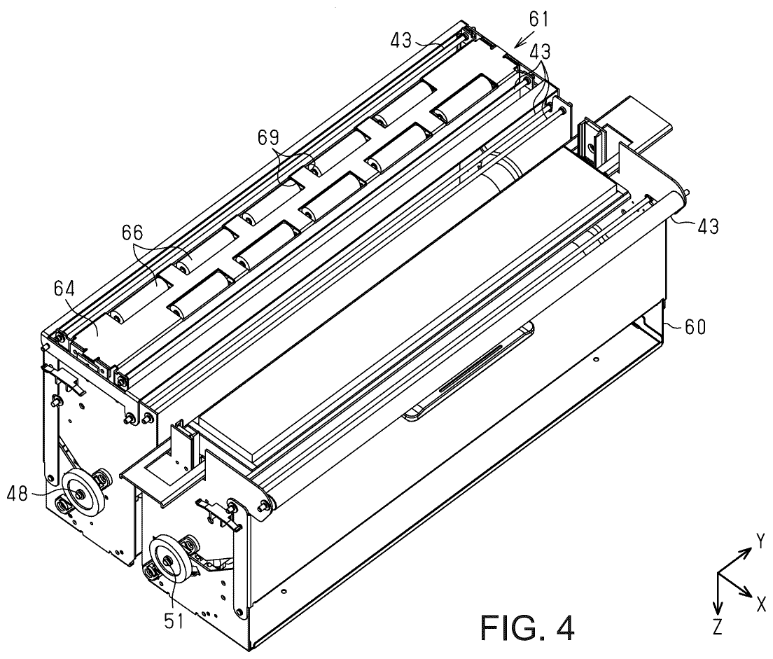

As shown in FIGS. 3 and 4, the cover member 64 has the same number of through holes 69 as the number of rollers 66. Part of rollers 66 protrude from the corresponding through holes 69. As shown in FIG. 3, the rollers 66 are mounted on the attachment members 65. The rollers 66 contact the back surface 54 of the absorbent member 42. The attachment member 65 rotatably holds the rollers 66. The rollers 66 may be driven to rotate by the transported absorbent member 42. The elastic members 67 push the attachment members 65. The elastic members 67 push up the absorbent member 42 through the attachment members 65 and the rollers 66. The elastic members 67 are, for example, springs.

The roller 66 has a cylindrical portion 71 and a shaft portion 72. The cylindrical portion 71 is a portion around which the absorbent member 42 is wound. The shaft portion 72 is a portion to be inserted into the cylindrical portion 71. The shaft portion 72 is mounted to the attachment member 65. The shaft portion 72 extends, for example, in the width direction Y. In the roller 66, the cylindrical portion 71 that comes into contact with wiping section 55 may be elastic. The cylindrical portion 71 may be formed of, for example, a member such as sponge or rubber. In this case, the absorbent member 42 is more easily brought into close contact with the nozzle forming surface 25.

A plurality of shaft portions 72 are attached to different attachment members 65. Therefore, the plurality of shaft portions 72 can each be tilted at different angles. Therefore, when wiping the nozzle forming surface 25, the plurality of cylindrical portions 71 can be tilted to conform to the nozzle forming surface 25. This makes it easier for the absorbent member 42 to come into close contact with the nozzle forming surface 25.

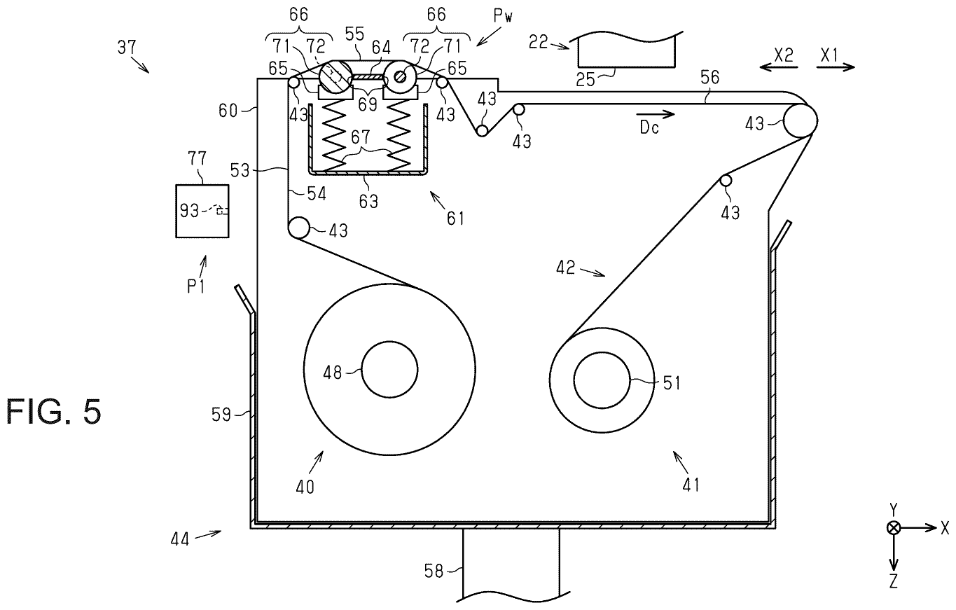

As shown in FIG. 5, the first movement mechanism 44 can move the absorbent member 42 to a wiping position Pw. The first movement mechanism 44 can move the wiping section 55 to the separation position Ps shown in FIG. 3 and the wiping position Pw shown in FIG. 5. When the absorbent member 42 is located at the wiping position Pw, the wiping section 55 is located above the nozzle forming surface 25. The wiping position Pw is a location at which the wiping section 55 can come into contact with the nozzle forming surface 25. When the absorbent member 42 is located at the wiping position Pw, the flat section 56 is located below the nozzle forming surface 25. The wiping position Pw is a location at which the flat section 56 is separated from the nozzle forming surface 25. The wiping section 55, when located at the wiping position Pw, interferes with the liquid ejection section 22 that reciprocates in the scanning direction X1.

The wiping device 37 can wipe the nozzle forming surface 25. The wiping section 55 can wipe the nozzle forming surface 25 by moving relative to the liquid ejection section 22. For example, wiping of the nozzle forming surface 25 may be performed by moving the liquid ejection section 22 in the wiping direction X2 with respect to the wiping section 55 which is stopped at the wiping position Pw. The wiping section 55 removes the first liquid or the like, that adheres to the nozzle forming surface 25. It is also referred as wiping when the wiping device 37 wipes the nozzle forming surface 25.

### Mixed Fluid Spray Section

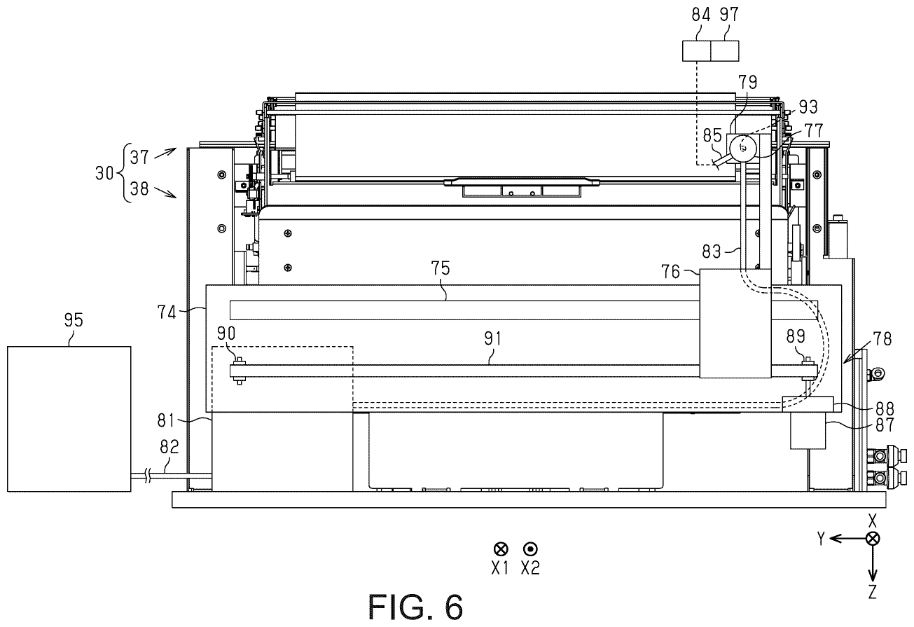

As shown in FIG. 6, the mixed fluid spray section 38 may be arranged upstream of the wiping device 37 in the scanning direction X1. In the scanning direction X1, the mixed fluid spray section 38 is arranged between the cleaning section 29 and the wiping section 55. The mixed fluid spray section 38 and the wiping section 55 may be provided side by side in the scanning direction X1.

The mixed fluid spray section 38 may be equipped with a guide frame 74, a guide rail 75, a second carriage 76, a fluid spray head 77, a second movement mechanism 78, and a third movement mechanism 79. The mixed fluid spray section 38 may be equipped with a sub-tank 81, an upstream supply path 82, a downstream supply path 83, an introduction section 84, and a gas supply path 85.

The guide frame 74 supports the guide rail 75 and the second movement mechanism 78. The guide rail 75 extends in the width direction Y. The guide rail 75 guides the second carriage 76 in the width direction Y.

The second carriage 76 is supported by the guide rail 75. The second carriage 76 is provided so as to be capable of reciprocating in the width direction Y along the guide rail 75. The second movement mechanism 78 may be equipped with a second drive source 87, a power transmission section 88, a drive pulley 89, a driven pulley 90, and a timing belt 91.

The second drive source 87 is, for example, a motor. The power transmission section 88 has, for example, a plurality of gears. The power transmission section 88 transmits the driving force of the second drive source 87 to the drive pulley 89. In other words, the second drive source 87 rotates the drive pulley 89.

The drive pulley 89 is rotatably supported by the guide frame 74. The driven pulley 90 is rotatably supported by the guide frame 74. The axis of the drive pulley 89 and the axis of the driven pulley 90 are parallel to each other.

The timing belt 91 is an annular belt. The timing belt 91 is looped around the drive pulley 89 and the driven pulley 90. A part of the timing belt 91 is fixed to the second carriage 76.

The second movement mechanism 78 transmits the drive force of the second drive source 87 to the second carriage 76 through the timing belt 91. The second movement mechanism 78 reciprocates the second carriage 76 in the width direction Y.

The fluid spray head 77 has a spray nozzle 93. The spray nozzle 93 can spray a mixed fluid of gas and a second liquid. The gas in the present embodiment is compressed air. The fluid spray head 77 is mounted on the second carriage 76. The fluid spray head 77 reciprocates in the width direction Y along with the movement of the second carriage 76. In other words, the spray nozzle 93 is movable in the width direction Y. The movement range of the spray nozzle 93 in the width direction Y may be larger than the width of the nozzle forming surface 25. The movement range of the spray nozzle 93 in the width direction Y may be larger than the width of the absorbent member 42. The fluid spray head 77 moistens the absorbent member 42 over the width direction Y by spraying the mixed fluid while moving in the width direction Y.

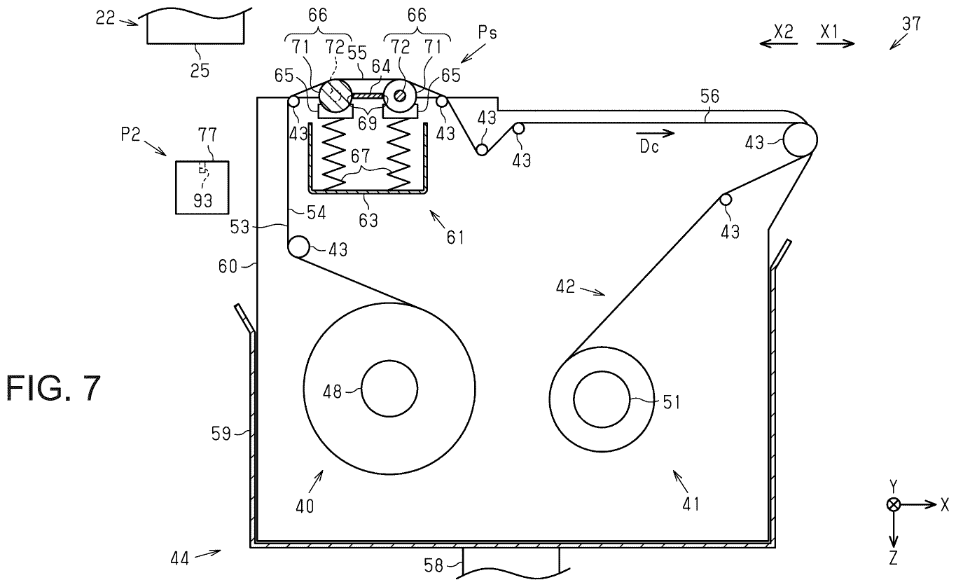

The third movement mechanism 79 moves the fluid spray head 77. The third movement mechanism 79 may pivot the fluid spray head 77 around an axis (not shown) extending in the width direction Y. The third movement mechanism 79 moves the spray nozzle 93. The spray nozzle 93 of the present embodiment is movable between a first position P1 shown in FIG. 3 and a second position P2 shown in FIG. 7.

As shown in FIG. 3, the first position P1 is a location for moistening the wiping section 55. Specifically, the spray nozzle 93 located at the first position P1 sprays the mixed fluid toward the absorbent member 42 between the winding section 41 and the wiping section 55. The spray nozzle 93 located at the first position P1 sprays the mixed fluid toward the part upstream side of the wiping section 55 in the transport direction Dc. The fluid spray head 77 may spray the mixed fluid in the scanning direction X1 or may spray the mixed fluid in a direction oblique to the scanning direction X1. The mixed fluid spray section 38 may spray the mixed fluid in a direction having a component facing the scanning direction X1.

The absorbent member 42 is moistened by the mixed fluid in the part upstream side of the wiping section 55 in the transport direction Dc. The moistened part of the absorbent member 42 moves in the transport direction Dc as the absorbent member 42 is wound by the winding section 41. In other words, the part where the mixed fluid is sprayed moves to a location where it comes into contact with the pressing section 61 and forms the wiping section 55.

As shown in FIG. 7, the second position P2 is a location at which the mixed fluid is sprayed onto the nozzle forming surface 25. The spray nozzle 93, when located at the second position P2, can face the nozzle forming surface 25. For example, the spray nozzle 93, when located at the second position P2, may spray the mixed fluid toward the nozzle forming surface 25 located immediately above.

As shown in FIG. 6, a main tank 95 may be provided in the liquid ejection device 11, or may be provided separately from the liquid ejection device 11. The main tank 95 stores the second liquid. The upstream supply path 82 connects the main tank 95 and the sub-tank 81. The upstream supply path 82 supplies the second liquid from the main tank 95 to the sub-tank 81. The sub-tank 81 can store the second liquid supplied from the main tank 95.

The downstream supply path 83 connects the sub-tank 81 and the fluid spray head 77. The downstream supply path 83 supplies the second liquid from the sub-tank 81 to the fluid spray head 77. The downstream supply path 83 is, for example, a tube. The downstream supply path 83 is deformable in accordance with the movement of the fluid spray head 77.

The introduction section 84 is connectable to a lead out section 97. The lead out section 97 may be provided in the liquid ejection device 11 or may be provided separately from the liquid ejection device 11. The lead out section 97 can lead out compressed air as the gas.

The gas supply path 85 connects the fluid spray head 77 and the introduction section 84. The gas supply path 85 supplies the compressed air introduced from the introduction section 84 to the fluid spray head 77. The gas supply path 85 is, for example, a tube. The gas supply path 85 can be deformed in accordance with the movement of the fluid spray head 77.

### Pressurized Cleaning

The control section 12 performs pressurized cleaning, for example, when a predetermined time has elapsed from the start of printing or when a predetermined time has elapsed from the previous maintenance. The control section 12 may perform pressurized cleaning of the plurality of liquid ejection sections 22 collectively or one by one. The following describes maintenance when performing the pressurized cleaning of a single liquid ejection section 22.

As shown in FIG. 7, when maintenance is performed, the control section 12 first moves the liquid ejection section 22 so that the nozzle forming surface 25 faces the fluid spray head 77. At this time, the absorbent member 42 is located at the separation position Ps.

The control section 12 drives the third movement mechanism 79 to move the spray nozzle 93 in the second position P2. The control section 12 may simultaneously perform the movement of the liquid ejection section 22 and the movement of the fluid spray head 77.

The control section 12 drives the second movement mechanism 78 to move the fluid spray head 77 in the width direction Y. The control section 12 may reciprocate the fluid spray head 77. The control section 12 causes the mixed fluid to be sprayed from the spray nozzle 93 toward the nozzle forming surface 25. The mixed fluid is sprayed onto the nozzle forming surface 25. The second liquid is applied to the nozzle forming surface 25. The mixed fluid is sprayed onto the liquid in the nozzles 26. The mixed fluid is sprayed onto the liquid that has thickened within the nozzles 26. The mixed fluid destroys the thickened state of the liquid in the nozzles 26.

Next, the control section 12 moves the liquid ejection section 22 so that the nozzle forming surface 25 faces the liquid receiving section 31. The control section 12 causes the pressurizing section 23 to discharge the liquid from the liquid ejection section 22. In other words, the control section 12 performs the pressurized cleaning. Since the thickened state of the liquid in the nozzles 26 is destroyed by the mixed fluid, the liquid is easily discharged during the pressurized cleaning. The liquid discharged from the liquid ejection section 22 is received by the liquid receiving section 31. Next, the control section 12 moves the liquid ejection section 22 so that the nozzle forming surface 25 faces the wiping section 55.

In the state where the wiping section 55 faces the nozzle forming surface 25, the control section 12 drives the first movement mechanism 44 to move the wiping section 55 to the wiping position Pw. The control section 12 causes the first movement mechanism 44 to move the wiping section 55 to a location where the wiping section 55 can come into contact with the nozzle forming surface 25. The control section 12 causes the wiping section 55 to come into contact with the nozzle forming surface 25 by the first movement mechanism 44.

After moving the wiping section 55 to the wiping position Pw, the control section 12 returns the wiping section 55 to the separation position Ps. In other words, the control section 12 causes the wiping section 55 to temporarily come into contact with the nozzle forming surface 25, and then causes the first movement mechanism 44 to separate the wiping section 55 from the nozzle forming surface 25. By contacting the nozzle forming surface 25, the wiping section 55 absorbs the first liquid attached to the nozzle forming surface 25 during the pressurized cleaning.

As shown in FIG. 3, the control section 12 moves the liquid ejection section 22 in the scanning direction X1. The control section 12 moves the liquid ejection section 22 to a location not facing the wiping section 55. The control section 12 drives the third movement mechanism 79 to move the spray nozzle 93 at the first position P1. The control section 12 drives the second movement mechanism 78 to move the fluid spray head 77 in the width direction Y. The control section 12 may reciprocate the fluid spray head 77. The control section 12 causes the mixed fluid to be sprayed from the spray nozzle 93, which is moving in the width direction Y, toward the absorbent member 42. The control section 12 moistens the absorbent member 42 with the second liquid.

The control section 12 drives the winding section 41 in a state in which the absorbent member 42 is separated from the nozzle forming surface 25. The control section 12 drives the winding section 41 to wind the absorbent member 42. By winding the absorbent member 42, the part that is located in the wiping section 55 and that absorbed the first liquid is moved from the wiping section 55, and the part which is moistened with the second liquid is located in the wiping section 55.

As shown in FIG. 5, the control section 12 drives the first movement mechanism 44 to move the wiping section 55 to the wiping position Pw. The control section 12 causes the first movement mechanism 44 to move the wiping section 55 to a location where the wiping section 55 can come into contact with the nozzle forming surface 25.

The control section 12 moves the liquid ejection section 22 in the wiping direction X2. The control section 12 causes the liquid ejection section 22 to move and pass through the wiping section 55. The control section 12 causes the wiping section 55 to wipe the nozzle forming surface 25. After wiping the nozzle forming surface 25, the control section 12 moves the wiping section 55 to the separation position Ps.

The control section 12 moves the liquid ejection section 22 such that the nozzle forming surface 25 faces the liquid receiving section 31. The control section 12 causes liquid to be ejected from the liquid ejection section 22 toward the liquid receiving section 31. In other words, the control section 12 causes the wiping section 55 to wipe the nozzle forming surface 25, and then ejects liquid as a dummy ejection from the liquid ejection section 22 toward the liquid receiving section 31. By this, the maintenance of a single liquid ejection section 22 is completed. The control section 12 performs maintenance on the plurality of liquid ejection sections 22 in order.

### Suction Cleaning

The control section 12 may perform suction cleaning instead of the above maintenance, that is the pressurized cleaning. When the clogging of nozzles 26 is not recovered by the pressurized cleaning, the control section 12 may perform the suction cleaning, for example. The control section 12 may perform suction cleaning of the plurality of liquid ejection sections 22 collectively or one by one. The following describes maintenance when performing the suction cleaning of a single liquid ejection section 22.

As shown in FIG. 7, the control section 12 causes the mixed fluid to be sprayed toward the nozzle forming surface 25 in the same manner as in the case of the pressurized cleaning. The mixed fluid is sprayed onto the liquid in the nozzles 26. The mixed fluid is sprayed onto the liquid that has thickened within the nozzles 26. The mixed fluid destroys the thickened state of the liquid in the nozzles 26.

The control section 12 moves the liquid ejection section 22 so that the nozzle forming surface 25 faces the cleaning section 29. The control section 12 performs suction cleaning of the liquid ejection section 22 by the cleaning section 29. In other words, the control section 12 causes the suction cap 35 to cap the liquid ejection section 22. The control section 12 causes inside the suction cap 35 to become a negative pressure, and causes the liquid to be discharged from the nozzles 26. Since the thickened state of the liquid in the nozzles 26 is destroyed by the mixed fluid, the liquid is easily discharged during the suction cleaning. By this, the liquid is discharged from the nozzles 26. When the suction cleaning is finished, the control section 12 releases the capping.

Next, in the same way as for the pressurized cleaning, the control section 12 sequentially performs bringing the wiping section 55 into temporary contact with the nozzle forming surface 25, wiping the nozzle forming surface 25 with the moistened wiping section 55, and causing the liquid ejection section 22 to perform a dummy ejection.

Specifically, the control section 12 moves the liquid ejection section 22 such that the nozzle forming surface 25 faces the wiping section 55. In the state where the wiping section 55 faces the nozzle forming surface 25, the control section 12 drives the first movement mechanism 44 to move the wiping section 55 to the wiping position Pw. The control section 12 causes the wiping section 55 to come into contact with the nozzle forming surface 25 by the first movement mechanism 44.

After moving the wiping section 55 to the wiping position Pw, the control section 12 returns the wiping section 55 to the separation position Ps. In other words, the control section 12 causes the wiping section 55 to temporarily come into contact with the nozzle forming surface 25, and then causes the first movement mechanism 44 to separate the wiping section 55 from the nozzle forming surface 25. By contacting the nozzle forming surface 25, the wiping section 55 absorbs the first liquid attached to the nozzle forming surface 25 during the suction cleaning.

As shown in FIG. 3, the control section 12 moves the liquid ejection section 22 in the scanning direction X1. The control section 12 moves the liquid ejection section 22 to a location not facing the wiping section 55. The control section 12 drives the third movement mechanism 79 to move the spray nozzle 93 at the first position P1. The control section 12 drives the second movement mechanism 78 to move the fluid spray head 77 in the width direction Y. The control section 12 may reciprocate the fluid spray head 77. The control section 12 causes the mixed fluid to be sprayed from the spray nozzle 93, which is moving in the width direction Y, toward the absorbent member 42. The control section 12 moistens the absorbent member 42 with the second liquid.

The control section 12 drives the winding section 41 in a state in which the absorbent member 42 is separated from the nozzle forming surface 25. The control section 12 drives the winding section 41 to wind the absorbent member 42. By winding the absorbent member 42, the part that is located in the wiping section 55 and that absorbed the first liquid is moved from the wiping section 55, and the part which is moistened with the second liquid is located in the wiping section 55.

The control section 12 drives the first movement mechanism 44 to move the wiping section 55 to the wiping position Pw. The control section 12 causes the first movement mechanism 44 to move the wiping section 55 to a location where the wiping section 55 can come into contact with the nozzle forming surface 25.

The control section 12 moves the liquid ejection section 22 in the wiping direction X2. The control section 12 causes the liquid ejection section 22 to move and pass through the wiping section 55. The control section 12 causes the wiping section 55 to wipe the nozzle forming surface 25. After wiping the nozzle forming surface 25, the control section 12 moves the wiping section 55 to the separation position Ps.

The control section 12 moves the liquid ejection section 22 such that the nozzle forming surface 25 faces the liquid receiving section 31. The control section 12 causes the liquid ejection section 22 to eject liquid toward the liquid receiving section 31. In other words, the control section 12 causes the wiping section 55 to wipe the nozzle forming surface 25, and then ejects liquid as a dummy ejection from the liquid ejection section 22 toward the liquid receiving section 31. By this, the maintenance of a single liquid ejection section 22 is completed. The control section 12 performs maintenance on the plurality of liquid ejection sections 22 in order.

### Operation of First Embodiment

The operation of the present embodiment will be described. The mixed fluid spray section 38 moistens the wiping section 55 before the wiping section 55 wipes the nozzle forming surface 25. The mixed fluid spray section 38 moistens the absorbent member 42 over the width direction Y. The wiping device 37 wipes the nozzle forming surface 25 with the moistened wiping section 55.

When the pressurized cleaning and the suction cleaning are performed, a part of the discharged first liquid adheres to the nozzle forming surface 25. The control section 12 can reduce liquid adhered to the nozzle forming surface 25 before wiping by causing the wiping section 55 to temporarily contact the nozzle forming surface 25 before wiping the nozzle forming surface 25. By this, speed of relative movement of the wiping section 55 and the liquid ejection section 22 during wiping can be increased. Since the amount of liquid mixed into the nozzles 26 can be reduced, the amount of liquid that is ejected as a dummy ejection can be reduced.

### Effects of First Embodiment

Effects of this embodiment will be described.

(1-1) The mixed fluid spray section 38 sprays the mixed fluid made by mixing the second liquid and the gas. By mixing the gas with the second liquid, droplet size of the second liquid to be sprayed can be reduced, and the second liquid can be sprayed over a wide range. Therefore, it can make the wiping section 55 a uniformly moistened state with a small amount of the second liquid.

(1-2) The spray nozzle 93 is movable in the width direction Y. The mixed fluid spray section 38, by spraying the mixed fluid from the spray nozzle 93 while moving in the width direction Y, can make easier the absorbent member 42 a uniformly moistened state even if the absorbent member 42 is elongated in the width direction Y.

(1-3) The spray nozzle 93 is movable to the first position P1 and to the second position P2. When the mixed fluid is sprayed from the spray nozzle 93 located at the first position P1, the wiping section 55 can be moistened. When the mixed fluid is sprayed from the spray nozzle 93 located at the second position P2, the mixed fluid can be sprayed onto the nozzle forming surface 25. This makes it easier recover the nozzles 26 even if the first liquid in the nozzles 26 is thickened and clogged. Therefore, it is possible to perform the moistening of the wiping section 55 and the maintenance of the liquid ejection section 22 using the mixed fluid spray section 38.

(1-4) The sub-tank 81 can store the second liquid supplied from the main tank 95. By storing the second liquid in the sub-tank 81, the second liquid can be easily supplied in accordance with spraying of the mixed fluid by the mixed fluid spray section 38.

(1-5) The mixed fluid spray section 38 can spray a mixed fluid of compressed air and the second liquid. Therefore, for example, compared to a case where a mixed fluid of uncompressed air and the second liquid is sprayed, it can make the wiping section 55 a uniformly moistened state with a smaller amount of the second liquid.

(1-6) The mixed fluid spray section 38 can introduce compressed air via the introduction section 84. By using the air compressed outside, the liquid ejection device 11 can be downsized.

(1-7) The mixed fluid spray section 38 sprays the mixed fluid in a direction that has a component facing in the scanning direction X1 in which the liquid ejection section 22 moves. Therefore, the mixed fluid spray section 38 can spray the mixed fluid from a region different from the region in which the liquid ejection section 22 moves. Therefore, the mixed fluid spray section 38 can be arranged at a location where it does not interfere with the movement of the liquid ejection section 22.

(1-8) The mixed fluid spray section 38 is arranged between the cleaning section 29 and the wiping section 55 in the scanning direction X1. Therefore, the liquid ejection section 22 on which the suction cleaning was performed using the cleaning section 29 can be quickly wiped with the moistened wiping section 55.

(1-9) In the scanning direction X1, the liquid receiving section 31 is arranged downstream side of the wiping section 55. Therefore, after the first liquid is discharged to the liquid receiving section 31, the nozzle forming surface 25 can be quickly wiped by the wiping section 55.

(1-10) The cleaning section 29, the wiping section 55, and the liquid receiving section 31 are arranged side by side in the scanning direction X1. Therefore, by moving the liquid ejection section 22, which has been subjected to suction cleaning by the cleaning section 29, in the scanning direction X1, wiping of the nozzle forming surface 25 and a dummy ejection can be performed. Therefore, it is possible to shorten the time required for the wiping and the dummy ejection compared to a case where the wiping and the dummy ejection are performed while the liquid ejection section 22 is reciprocated in the scanning direction X1.

(1-11) The liquid receiving section 31 receives the first liquid discharged from the liquid ejection section 22 by the pressurizing section 23. Therefore, the first liquid that is ejected as a dummy ejection from the head and the first liquid that is pressurized and discharged from the liquid ejection section 22 can be received in a single liquid receiving section 31.

### Second Embodiment

Next, a second embodiment of the maintenance unit and the liquid ejection device will be described with reference to the drawings. Note that the second embodiment differs from the first embodiment in that the mixed fluid spray section does not include the third moving mechanism. Since it is substantially the same as the first embodiment in other respects, by attaching the same reference numerals for the same configurations, redundant description will be omitted.

The maintenance unit 30 of the second embodiment is arranged between the cleaning section 29 and the liquid receiving section 31, similarly to the first embodiment. In other words, the wiping section 55 is arranged between the cleaning section 29 and the liquid receiving section 31 in the scanning direction X1. The liquid receiving section 31 can receive the first liquid that is ejected as a dummy ejection from the liquid ejection section 22 and the first liquid that is discharged from the liquid ejection section 22 by pressurization of the pressurizing section 23.

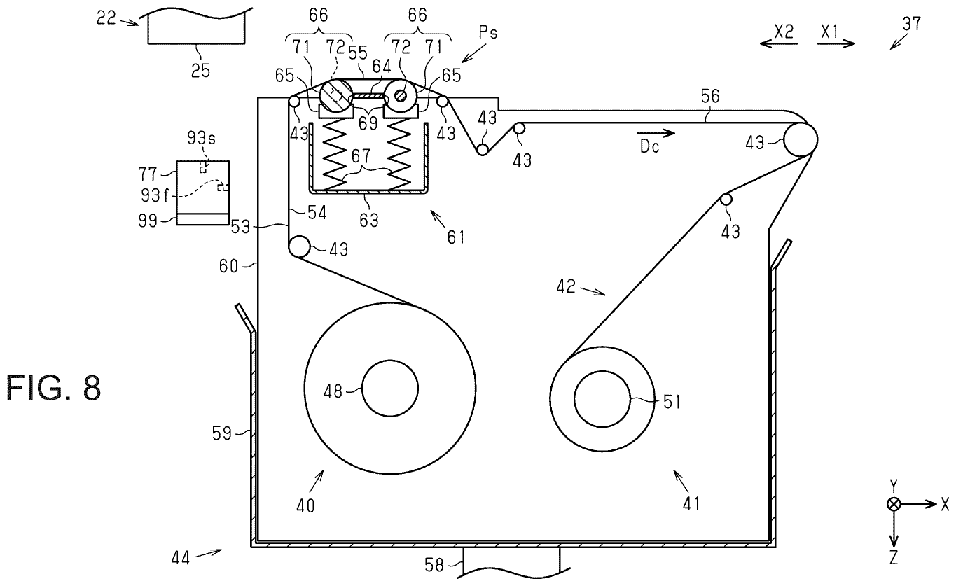

As shown in FIG. 8, the fluid spray head 77 has a first spray nozzle 93f and a second spray nozzle 93s. The first spray nozzle 93f can face the absorbent member 42. The first spray nozzle 93f sprays the mixed fluid in a direction having a component facing in the scanning direction X1. The fluid spray head 77 moistens the absorbent member 42 in the width direction Y by spraying the mixed fluid from the first spray nozzle 93f while moving in the width direction Y.

The second spray nozzle 93s can face the nozzle forming surface 25. The second spray nozzle 93s can spray the mixed fluid onto the nozzle forming surface 25. The second spray nozzle 93s may spray the mixed fluid upward in the vertical direction Z. The fluid spray head 77 may spray the mixed fluid onto the nozzle forming surface 25 by spraying the mixed fluid from the second spray nozzle 93s while moving in the width direction Y.

The mixed fluid spray section 38 may have a switching section 99. The switching section 99 can switch between the spraying of the mixed fluid from the first spray nozzle 93f and the spraying of the mixed fluid from the second spray nozzle 93s.

### Operation of Second Embodiment

The operation of the present embodiment will be described. The timing at which the mixed fluid spray section 38 sprays the mixed fluid to the absorbent member 42 and the nozzle forming surface 25 is the same as that of the first embodiment.

When spraying the mixed fluid to the absorbent member 42, the fluid spray head 77 sprays the mixed fluid from the first spray nozzle 93f to the absorbent member 42 while moving in the width direction Y. When spraying the mixed fluid to the nozzle forming surface 25, the fluid spray head 77 sprays the mixed fluid from the second spray nozzle 93s to the nozzle forming surface 25 while moving in the width direction Y.

### Effects of Second Embodiment

Effects of this embodiment will be described.

(2-1) The mixed fluid spray section 38 has the second spray nozzle 93s in addition to the first spray nozzle 93f. When the mixed fluid is sprayed from the second spray nozzle 93s, the mixed fluid can be sprayed onto the nozzle forming surface 25. Therefore, the mixed fluid spray section 38 can perform both the moistening of the wiping section 55 and the maintenance of the liquid ejection section 22.

(2-2) The switching section 99 switches between the spraying of the mixed fluid from the first spray nozzle 93f and the spraying of the mixed fluid from the second spray nozzle 93s. Therefore, the mixed fluid spray section 38 can select the spraying destination of the mixed fluid.

### Modifications

The present embodiment can be implemented with the following modifications. The present embodiment and the following modifications can be implemented in combination with each other as long as there is no technical contradiction.
The wiping device 37 may cause the wiping section 55 to wipe the nozzle forming surface 25 as it is after at least one of the pressurized cleaning and the suction cleaning.
The liquid ejection device 11 may be capable of performing one of the pressurized cleaning and the suction cleaning. The liquid ejection device 11 may be equipped with one of the pressurizing section 23 and the cleaning section 29.
The absorbent member 42 may receive liquid that is ejected as a dummy ejection from the liquid ejection section 22. The absorbent member 42 may receive liquid discharged by the pressurized cleaning. For example, the flat section 56 may receive liquid discharged from the liquid ejection section 22. In this case, the liquid ejection device 11 may be configured not to be equipped with the liquid receiving section 31.
The wiping device 37 may be equipped with a transport section that transports the band-shaped absorbent member 42. The transport section may collect the used absorbent member 42 so as to be folded.
The second liquid may be, for example, a reaction liquid, water, a solvent, a moisture retention liquid, a washing liquid, or the like.
The wiping section 55 may wipe the nozzle forming surface 25 by contacting the liquid ejection section 22, which moves in the scanning direction X1. For example, the control section 12 may moisten the wiping section 55 and move the wiping section 55 to the wiping position Pw during the suction cleaning. The control section 12 may cause the wiping section 55 to wipe the nozzle forming surface 25 by causing the liquid ejection section 22 that has been performed the suction cleaning to move in the scanning direction X1 and to pass through the wiping section 55. The liquid ejection section 22 may perform a dummy ejection at a timing when the liquid ejection section 22 passes through the flat section 56.
Either the mixed fluid spray section 38 or the liquid ejection device 11 may be equipped with a compressor that is capable of compressing air. The gas supply path 85 may connect the compressor and the fluid spray head 77.
The mixed fluid spray section 38 may not spray the mixed fluid to the nozzle forming surface 25. In this case, the mixed fluid spray section 38 of the first embodiment may be configured not to be equipped with the third movement mechanism 79. The fluid spray head 77 of the second embodiment may be configured not to have the second spray nozzle 93s.
The mixed fluid spray section 38 may be capable of spraying the mixed fluid simultaneously from both the first spray nozzle 93f and the second spray nozzle 93s. The mixed fluid spray section 38 may simultaneously spray the mixed fluid to the absorbent member 42 and to the nozzle forming surface 25.
The spray nozzle 93 may be capable of facing the wiping section 55. The mixed fluid spray section 38 may directly spray the mixed fluid to the wiping section 55.
The mixed fluid spray section 38 may spray the mixed fluid in the vertical direction Z.
The pressure of the gas supplied to the fluid spray head 77 may be atmospheric pressure. The gas supplied to the fluid spray head 77 is not limited to air, and may be nitrogen or the like.
The mixed fluid spray section 38 may be configured not to be equipped with the second movement mechanism 78. In this case, the length of the spray nozzle 93 in the width direction Y is desirably equal to or longer than the length of the absorbent member 42 in the width direction Y, and is desirably equal to or longer than the length of the nozzle forming surface 25 in the width direction Y. The fluid spray head 77 may be fixed.
The maintenance unit 30 may be provided separately from the liquid ejection device 11.
The liquid ejection device 11 may be a liquid ejection device that sprays or ejects liquid other than ink. The state of the liquid which is ejected from the liquid ejection device in the form of a minute amount of liquid droplets includes granular shape, teardrop shape, and a shape with thread-like tail. Here, the liquid may be a material that can be ejected from the liquid ejection device. For example, the liquid may be in a state where a substance is in liquid phase, and includes fluid bodies such as liquid body having high or low viscosity, sols, gel waters, other inorganic solvents, organic solvents, solutions, liquid resins, liquid metals, and molten metal. The liquid includes not only liquid as one state of substance but also liquid in which particles of functional materials made of solid materials such as pigments or metal particles are dissolved, dispersed, or mixed in a solvent. Typical examples of the liquid include ink and liquid crystal as described in the above embodiment. Here, the ink includes various liquid compositions such as general water-based ink, oil-based ink, gel ink, and hot-melt ink. As a specific example of the liquid ejection device, there are devices that eject liquid containing materials such as electrode materials or color materials in a dispersed or dissolved form, which are used for manufacturing a liquid crystal display, an electroluminescence display, a surface emitting display, a color filter, and the like. The liquid ejection device may be a device for ejecting biological organic matter used for the manufacture of biochips, a device for ejecting liquid to be a sample used as a precision pipette, a textile printing device, a micro dispenser, or the like. The liquid ejection device may be a device that discharges lubricating oil in a pinpoint manner to precision machinery such as watches or cameras, or a device that discharges transparent resin liquid such as ultraviolet curable resin onto a substrate in order to form micro hemispherical lenses, optical lenses, or the like, which are used in optical communication elements or the like. The liquid ejection device may be a device that ejects etching solution such as acid or alkali to etch substrates or the like.

### Definition

The expression “at least one” as used in this specification means “one or more” of the desired options. As an example, the expression “at least one” as used in this specification means “only one option” or “both of the two options” if the number of options is two. As another example, the expression “at least one” as used in this specification means “only one option”, “any combination of two options”, or “any combination of three or more options” if the number of options is three or more.

### Notes

Hereinafter, technical ideas grasped from the above-described embodiments and modifications, and operations and effects thereof will be described.

(A) The maintenance unit includes a wiping section configured to wipe a nozzle forming surface of a liquid ejection section in which a nozzle that ejects a first liquid is formed and a mixed fluid spray section that sprays a mixed fluid of gas and a second liquid from a spray nozzle to moisten the wiping section.

According to this configuration, the mixed fluid spray section sprays the mixed fluid made by mixing the second liquid and the gas. By mixing the gas with the second liquid, droplet size of the second liquid to be sprayed can be reduced, and the second liquid can be sprayed over a wide range. Therefore, it can make the wiping section a uniformly moistened state with a small amount of the second liquid.

(B) The maintenance unit according to (A) described above may be configured such that the wiping section is configured with a band-shaped absorbent member configured to absorb liquid, a length of the absorbent member in a width direction is longer than a length of the nozzle forming surface in the width direction, and the spray nozzle is movable in the width direction.

According to this configuration, the spray nozzle is movable in the width direction. By spraying the mixed fluid from the spray nozzle that moves in the width direction, the mixed fluid spray section can make easier the absorbent member a uniformly moistened state even if the absorbent member is elongated in the width direction.

(C) The maintenance unit according to (A) or (B) described above may be configured such that the spray nozzle is movable between a first position for moistening the wiping section and a second position for spraying the mixed fluid at the nozzle forming surface.

According to this configuration, the spray nozzle is movable between the first position and the second position. When the mixed fluid is sprayed from the spray nozzle located at the first position, the wiping section can be moistened. When the mixed fluid is sprayed from the spray nozzle located at the second position, the mixed fluid can be sprayed onto the nozzle forming surface. Therefore, even when the first liquid in the nozzle is thickened and clogged, it can be easily recovered. Therefore, the mixed fluid spray section can perform the moistening of the wiping section and the maintenance of the liquid ejection section.

(D) The maintenance unit according to (A) or (B) described above may be configured such that assuming that the spray nozzle is a first spray nozzle, the mixed fluid spray section has a second spray nozzle configured to spray the mixed fluid onto the nozzle forming surface.

According to this configuration, the mixed fluid spray section has a second spray nozzle in addition to the first spray nozzle. When the mixed fluid is sprayed from the second spray nozzle, the mixed fluid can be sprayed onto the nozzle forming surface. Therefore, the mixed fluid spray section can perform both the moistening of the wiping section and the maintenance of the liquid ejection section.

(E) The maintenance unit according to (D) described above may be configured to such that the mixed fluid spray section has a switching section that enables switching between spraying of the mixed fluid from the first spray nozzle and spraying of the mixed fluid from the second spray nozzle.

According to this configuration, the switching section switches between the spraying of the mixed fluid from the first spray nozzle and the spraying of the mixed fluid from the second spray nozzle. Therefore, the mixed fluid spray section can select the spraying destination of the mixed fluid.

(F) The maintenance unit according to (A) to (E) described above may be configured such that further including a sub-tank configured to store the second liquid supplied from a main tank that stores the second liquid. According to this configuration, the sub-tank can store the second liquid supplied from the main tank. By storing the second liquid in the sub-tank, the sub-tank can supply easier the second liquid in accordance with the spraying of the mixed fluid by the mixed fluid spray section.

(G) The maintenance unit according to (A) to (F) described above may be configured such that the gas is compressed air. According to this configuration, the mixed fluid spray section can spray the mixed fluid of the compressed air and the second liquid. Therefore, for example, compared to a case where a mixed fluid of uncompressed air and the second liquid is sprayed, it can make the wiping section a uniformly moistened state with a smaller amount of the second liquid.

(H) A liquid ejection device includes a liquid ejection section that has a nozzle forming surface in which a nozzle that ejects a first liquid is formed and a maintenance unit according to (A) to (G) described above. According to this configuration, the liquid ejection device can achieve the same effects as those of the maintenance unit.

(I) The liquid ejection device according to (H) described above may be configured such that the mixed fluid spray section has an introduction section that is connectable to a lead out section configured to lead out compressed air as the gas. According to this configuration, the mixed fluid spray section can introduce the compressed air through the introduction section. By using the air compressed outside, the liquid ejection device can be downsized.

(J) The liquid ejection device according to (I) described above may be configured such that the liquid ejection section is movable in a scanning direction, the mixed fluid spray section and the wiping section are provided side by side in the scanning direction, and the mixed fluid spray section sprays the mixed fluid in a direction that includes a component facing the scanning direction.

According to this configuration, the mixed fluid spray section sprays the mixed fluid in a direction having a component facing the scanning direction in which the liquid ejection section moves. Therefore, the mixed fluid spray section can spray the mixed fluid from a region different from the region in which the liquid ejection section moves. Therefore, the mixed fluid spray section can be arranged at a location where it does not interfere with the movement of the liquid ejection section.

(K) The liquid ejection device according to (H) to (J) described above may be configured such that further including a cleaning section configured to perform suction cleaning of the liquid ejection section by sucking the first liquid from the liquid ejection section, wherein in the scanning direction, the mixed fluid spray section is arranged between the cleaning section and the wiping section.

According to this configuration, the mixed fluid spray section is arranged between the cleaning section and the wiping section in the scanning direction. Therefore, the liquid ejection section on which the suction cleaning was performed using the cleaning section can be quickly wiped with the moistened wiping section.

(L) The liquid ejection device according to (H) to (K) described above may be configured such that further including a pressurizing section that pressurizes inside the liquid ejection section to discharge the first liquid from the liquid ejection section and a liquid receiving section that receives the first liquid discharged from the liquid ejection section by the pressure applied by the pressurizing section, wherein in the scanning direction, the liquid receiving section is arranged downstream of the wiping section.

According to this configuration, in the scanning direction, the liquid receiving section is arranged the downstream side of the wiping section. Therefore, after the first liquid is discharged to the liquid receiving section, the nozzle forming surface can be quickly wiped by the wiping section.

(M) The liquid ejection device according to (H) to (L) described above may be configured such that further including a liquid receiving section that receives the first liquid ejected as a dummy ejection from the liquid ejection section, wherein in the scanning direction, the wiping section is arranged between the cleaning section and the liquid receiving section.

According to this configuration, the cleaning section, the wiping section, and the liquid receiving section are arranged side by side in the scanning direction. Therefore, by moving the liquid ejection section, which has been subjected to suction cleaning by the cleaning section, in the scanning direction, wiping of the nozzle forming surface and a dummy ejection can be perform. Therefore, compared to a case where the wiping and the dummy ejection are performed while reciprocating the liquid ejection section in the scanning direction, the time required for the wiping and the dummy ejection can be reduced.

(N) The liquid ejection device according to (H) to (M) described above may be configured such that further including a pressurizing section that pressurizes inside the liquid ejection section to discharge the first liquid from the liquid ejection section, wherein the liquid receiving section is configured to receive the first liquid discharged from the liquid ejection section by the pressure applied by the pressurizing section.

According to this configuration, the liquid receiving section receives the first liquid discharged from the liquid ejection section by the pressurizing section. Therefore, the first liquid that is ejected as a dummy ejection from the head and the first liquid that is pressurized and discharged from the liquid ejection section can be received in a single liquid receiving section.

What is claimed is:

1. A maintenance unit comprising:
a wiping section configured to wipe a nozzle forming surface of a liquid ejection section in which a nozzle that ejects a first liquid is formed and
a mixed fluid spray section that sprays a mixed fluid of gas and a second liquid from a spray nozzle to moisten the wiping section.

2. The maintenance unit according to claim 1, wherein
the wiping section is configured with a band-shaped absorbent member configured to absorb liquid,
a length of the absorbent member in a width direction is longer than a length of the nozzle forming surface in the width direction, and
the spray nozzle is movable in the width direction.

3. The maintenance unit according to claim 1, wherein
the spray nozzle is movable between a first position for moistening the wiping section and a second position for spraying the mixed fluid at the nozzle forming surface.

4. The maintenance unit according to claim 1, wherein
assuming that the spray nozzle is a first spray nozzle, the mixed fluid spray section has a second spray nozzle configured to spray the mixed fluid onto the nozzle forming surface.

5. The maintenance unit according to claim 4, wherein
the mixed fluid spray section has a switching section that enables switching between spraying of the mixed fluid from the first spray nozzle and spraying of the mixed fluid from the second spray nozzle.

6. The maintenance unit according to claim 1, further comprising:
a sub-tank configured to store the second liquid supplied from a main tank that stores the second liquid.

7. The maintenance unit according to claim 1, wherein
the gas is compressed air.

8. A liquid ejection device comprising:
a liquid ejection section that has a nozzle forming surface in which a nozzle that ejects a first liquid is formed and
the maintenance unit according to claim 1.

9. The liquid ejection device according to claim 8, wherein
the mixed fluid spray section has an introduction section that is connectable to a lead out section configured to lead out compressed air as the gas.

10. The liquid ejection device according to claim 8, wherein
the liquid ejection section is movable in a scanning direction,
the mixed fluid spray section and the wiping section are provided side by side in the scanning direction, and
the mixed fluid spray section sprays the mixed fluid in a direction that includes a component facing the scanning direction.

11. The liquid ejection device according to claim 10, further comprising:
a cleaning section configured to perform suction cleaning of the liquid ejection section by sucking the first liquid from the liquid ejection section, wherein
in the scanning direction, the mixed fluid spray section is arranged between the cleaning section and the wiping section.

12. The liquid ejection device according to claim 11, further comprising:
a pressurizing section that pressurizes inside the liquid ejection section to discharge the first liquid from the liquid ejection section and
a liquid receiving section that receives the first liquid discharged from the liquid ejection section by the pressure applied by the pressurizing section, wherein
in the scanning direction, the liquid receiving section is arranged downstream of the wiping section.

13. The liquid ejection device according to claim 11, further comprising:
a liquid receiving section that receives the first liquid ejected as a dummy ejection from the liquid ejection section, wherein
in the scanning direction, the wiping section is arranged between the cleaning section and the liquid receiving section.

14. The liquid ejection device according to claim 13, further comprising:
a pressurizing section that pressurizes inside the liquid ejection section to discharge the first liquid from the liquid ejection section, wherein
the liquid receiving section is configured to receive the first liquid discharged from the liquid ejection section by the pressure applied by the pressurizing section.
